(19) United States
(12) Patent Application Publication
(10) Pub. No.: US 2023/0055840 A1
(43) Pub. Date: Feb. 23, 2023

(54) Dynamic Determination and Notification for Alternation of Fulfillment Mode for A Network-Based Service

(71) Applicant: Uber Technologies, Inc., San Francisco, CA (US)

(72) Inventors: Boting Li, New York, NY (US); Vishal Soni, Westfield, NJ (US); Jason Wien, Topanga, CA (US)

(21) Appl. No.: 17/891,433

(22) Filed: Aug. 19, 2022

Related U.S. Application Data
(60) Provisional application No. 63/235,306, filed on Aug. 20, 2021.

(51) Int. Cl. G06Q 10/08; G06Q 30/02

(52) U.S. Cl. CPC G06Q 10/087; G06Q 10/0836; G06Q 10/0838; G06Q 30/0235

(57) ABSTRACT

This application describes a system associated with a network-based delivery service that receives item delivery requests from various individuals. The system determines whether the item(s) in the item delivery requests can be delivered. If not, the system generates and provides a selectable notification the various individuals. The selectable notification prompts the various individuals to pick up the item(s) in the item delivery request instead of waiting for delivery of the item(s).

### RELATED APPLICATIONS

This application claims the benefit of priority to U.S. Provisional Patent Application Ser. No. 63/235,306, filed Aug. 20, 2021, which is hereby incorporated by reference.

### BACKGROUND

In delivery services, it may be difficult to find couriers that deliver items from an entity to a consumer once an order has been placed. If a courier cannot be found, the entity and/or the consumer may become frustrated.

### SUMMARY

The present application relates to network-based delivery services. In some examples, the present application relates to network-based food delivery services. More specifically, the present application describes a system that determines delivery conditions for a particular geographic area. If the determined delivery conditions reach a delivery condition threshold (e.g., the system determines that the number of requests to be fulfilled by delivery exceeds a determined number of couriers by over a threshold amount), the system generates and provides a selectable notification to a computing device associated with an individual that submitted a request for one or more items, a fulfillment mode of the request being delivery. In an example, the selectable notification prompts the individual to pick up the item(s) in the request instead of waiting for delivery of the item(s). Although a delivery condition threshold is specifically mentioned, as will be explained in greater detail below, the system may consider other factors when determining whether to generate and provide the selectable notification to the computing device associated with the individual.

Accordingly, the present application describes a method that includes receiving, from a computing device, a request for one or more items, a fulfillment mode of the request being delivery. When the request is received, the system determines a delivery condition associated with a determined geographic area associated with the computing device. Based on determining that the delivery condition reaches a delivery condition threshold, a selectable notification is generated. In at least one example, the selectable notification may notify an individual associated with the computing device that the delivery condition has reached the delivery condition threshold. In other examples, the selectable notification may not indicate that the delivery condition has reached the delivery condition threshold. Once generated, the selectable notification is provided to the computing device. Based on receiving a selection of the selectable notification, the fulfillment mode of the request is changed from delivery to pick up.

The present application also describes a method for changing an item delivery option to an item pick up option. In an example, the method includes receiving, from a computing device, a request for one or more items, a fulfillment mode of the request being delivery. The request includes an item to be prepared by an entity. The entity is associated with a location and the computing device is associated with another location. Based on receiving the request, an attempt is performed to identify a courier to deliver the item is performed based on a set of conditions (e.g., courier availability, courier acceptance of the delivery request, distance between a courier and the entity location and/or the delivery location, estimated travel time). The courier is to deliver the item from the location of the entity to the determined location of the computing device. Based on the set of conditions, a pick up notification is generated. The pick up notification may then be provided to and displayed on a user interface of the computing device.

This application also describes a system for determining a courier for delivering items. In an example, the system includes a processor and a memory. The memory is communicatively coupled to the processor and stores instructions that, when executed by the processor, perform operations. In an example, the operations include receiving, from a computing device, a request for one or more items, a fulfillment mode of the request being delivery. Based on receiving the request, the system evaluates one or more factors, such as a previous estimated time to delivery, a current estimated time to delivery, a threshold difference between the previous and estimated time to delivery, a number of requests for a determined geographic area associated with the request, a number of available couriers for the determined geographic area reaches, etc. Based on determining that the difference reaches the difference threshold, a selectable notification for the computing device is generated. The selectable notification notifies an individual associated with the computing device that the difference has reached the difference threshold. The selectable notification is provided to the computing device. Based on receiving a selection of the selectable notification, the fulfillment mode of the request is changed from delivery to pick up.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an example system for determining an availability of a courier to deliver one or more items to an individual according to an example.

FIG. 1B illustrates the example system of FIG. 1A in which a switch to pick up notification is provided to the computing device associated with the individual according to an example.

FIG. 1C illustrates the example system of FIG. 1B in which a pick up instruction is provided to the computing device associated with the individual in response to the individual selecting the switch to pick up notification according to an example.

FIG. 2A illustrates an example user interface that includes a switch to pick up notification according to an example.

FIG. 2B illustrates another example user interface that include a switch to pick up notification according to an example.

FIG. 2C illustrates another example user interface that is provided to the computing device in response to an individual selecting a switch to pick up notification according to an example.

FIG. 2D illustrates an example user interface that is provided to the computing device when an order is canceled according to an example.

FIG. 3 illustrates a method for determining whether to provide a switch to pick up notification to a computing device associated with an individual according to an example.

FIG. 4 is a block diagram of a computing device according to one or more examples.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A network-based delivery service typically receives a number of different requests for one or more items from various computing devices, where the fulfillment mode of the requests is delivery. The request may be a request for a food item to be delivered (e.g., a food delivery request). In other examples, the request may be for a non-food item (e.g., toilet paper, light bulb, concert ticket, prescription) to be delivered. While the request may be for delivery of a food item or a non-food item, the non-limiting examples described below will be directed to food delivery requests.

Each food delivery request may include a request for food item(s) from a particular restaurant, location, or entity (e.g., retail store, food truck, food stand, residence, individual). The food delivery request may also include a delivery address to which the food item(s) are to be delivered. When a food delivery request is received by the network-based food delivery service, the network-based food delivery service may identify a courier that is available, willing, etc. to pick up the food item(s) from the restaurant and deliver the food item(s) to the delivery address.

However, in certain geographic areas and/or during certain times of the day, the number of food delivery requests may be such that the courier supply conditions are not sufficient for performing one or more food delivery requests. If the supply conditions are not sufficient for performing one or more food delivery requests, there is a risk that the food delivery request will not be fulfilled.

In another example, if the number of food delivery requests exceeds the number of available couriers, the food item(s) may be prepared by the restaurant but not picked up by a courier while the food item is fresh or optimal. As such, the individual that placed the food delivery request may be disappointed in the quality of the food item(s) and/or in the network-based food delivery service. In yet another example, if the number of food delivery requests exceeds the number of available couriers, the individual may simply cancel her order or her order may be canceled by the network-based food delivery service. In either case, the individual may become dissatisfied with the network-based food delivery service.

In another example, certain conditions may delay or prevent a matched courier from picking-up a food item. For example, a courier can be selected to pick up an item included in a food delivery request. Prior to picking up the item, the courier may experience a change in traffic conditions (e.g., congestion, road closure, accident) that delays the courier or prevents the courier from picking up the item. The traffic condition can occur, for instance, while the courier is enroute to the entity associated with the item (e.g., the restaurant or other designated pick up location). Additionally, or alternatively, the traffic condition can occur while the courier is performing another service (e.g., completing another delivery service, picking up another item, transporting a user). As a result of the delay, the courier may not be able to pick up the item within a threshold time or may not be able to pick up the item at all (e.g., due the closure of a needed road).

In order to remedy the above, the present application describes a switch to pick up system that surfaces or otherwise provides a selectable “pick up” notification to a computing device associated with an individual. The selectable pick up notification prompts the individual to pick up her order instead of waiting for a courier to become available. In an example, the selectable pick up notification is provided to the computing device associated with the individual after the individual has completed a checkout process associated with the food delivery request. However, the selectable pick up notification may be removed or otherwise made unavailable once a courier has been found to deliver the food item(s) associated with the food delivery request.

In an example, the selectable pick up notification may be provided to the computing device associated with the individual any time before the checkout process associated with the food delivery request has been completed. For example, while the user is reviewing food item choices, placing an order for a food item, or completing the checkout process, the system may surface the selectable switch to pick up notification. In another example, the selectable pick up notification is provided to the computing device of the individual based on determining that a delivery condition for a particular geographic area reaches a delivery condition threshold. For example, the delivery condition may be a condition in which a number of food delivery requests exceeds, or is projected to exceed, a number of available couriers for a given time period and/or in a particular geographic area.

The selectable pick up notification may be provided to the computing device of the individual based on other factors. For example, the switch to pick up system may determine a likelihood or a probability that the individual will cancel the food delivery request. The likelihood or probability may be based, at least in part, on historical information associated with the individual. In another example, the selectable pick up notification may be provided to the computing device of the individual based, at least in part, on a likelihood or probability that the food delivery request will not be fulfilled. In yet another example, the pick up notification may be provided to the computing device of the individual based on time constraints associated with the restaurant (e.g., the restaurant may be closed by the estimated time that a courier will be available), a size or number of food items in the food delivery request, the cost of food item(s) in the food delivery request, a delivery location specified by the food delivery request, an amount of time that has passed since the food delivery request has been received, or a time of day. Although specific examples have been given, other factors may be considered.

The switch to pick up system may also determine an incentive to provide the individual should the individual select the selectable pick up notification. In an example, the incentive may be a cost savings, a monetary value, a reward in a rewards program, or a discount on a future purchase.

The type of the incentive and/or a value of the incentive may be based on an amount of time that has passed since the food delivery request has been received by the switch to pick up system. In another example, the type of incentive and/or a value of the incentive, may be based on a determination (or a determined probability) as to whether the food delivery request will go unfulfilled. In yet another example, the type of incentive and/or a value of the incentive may be based on a determination (or a determined probability) that the individual will cancel the food delivery request. In an example, when the incentive is determined, the incentive may be provided to the computing device along with the selectable pick up notification.

In response to receiving an indication that the selectable pick up notification has been selected, the switch to pick up system may provide directions from the current location of the computing device to a pick up location. Additionally, when the selectable pick up notification is selected, the switch to pick up system will stop determining or otherwise identifying available couriers for that particular food delivery request.

Providing a selectable pick up notification may improve the functioning of computing systems used to optimize network-based delivery services. By providing a selectable pick up notification under certain conditions, the system may avoid performing computationally intensive operations to identify a courier available to pick up the food item(s) from an entity and deliver the food item(s) to an individual. For example, during peak times (e.g., lunch hours, dinner hours, during large events) food delivery requests are typically increased, which causes the system to perform numerous computationally intensive operations during the time period. As such, the system may provide the selectable pick up notification (or provide the selectable pick up notification to a larger number of individuals) during peak times to alleviate or stabilize the computational load on the system. Thus, computer and networking resources may be saved by providing a selectable pick up notification in certain situations based on various factors.

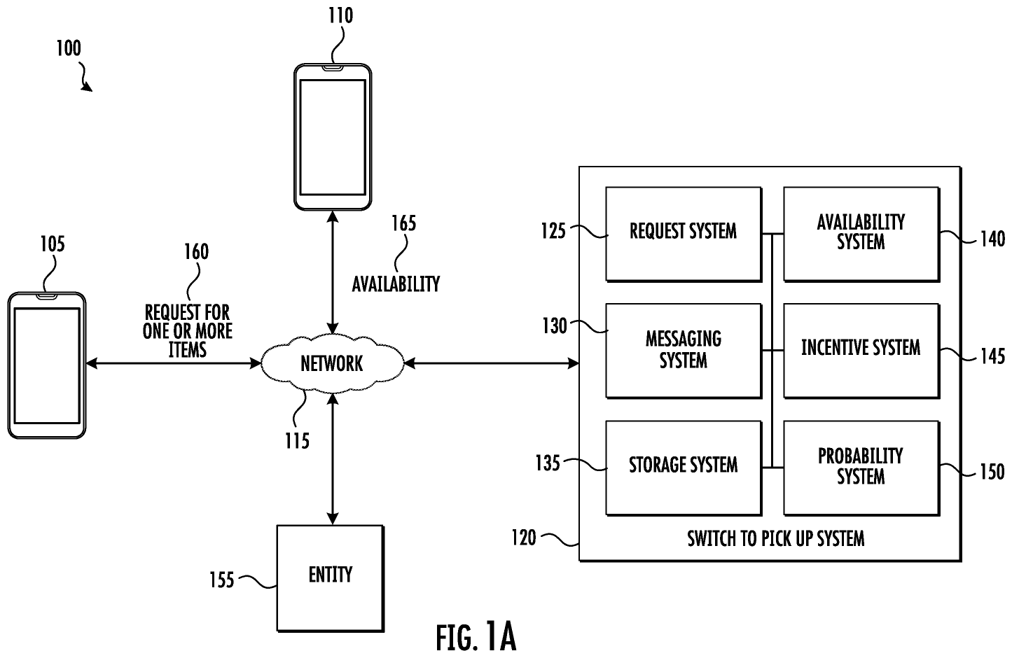

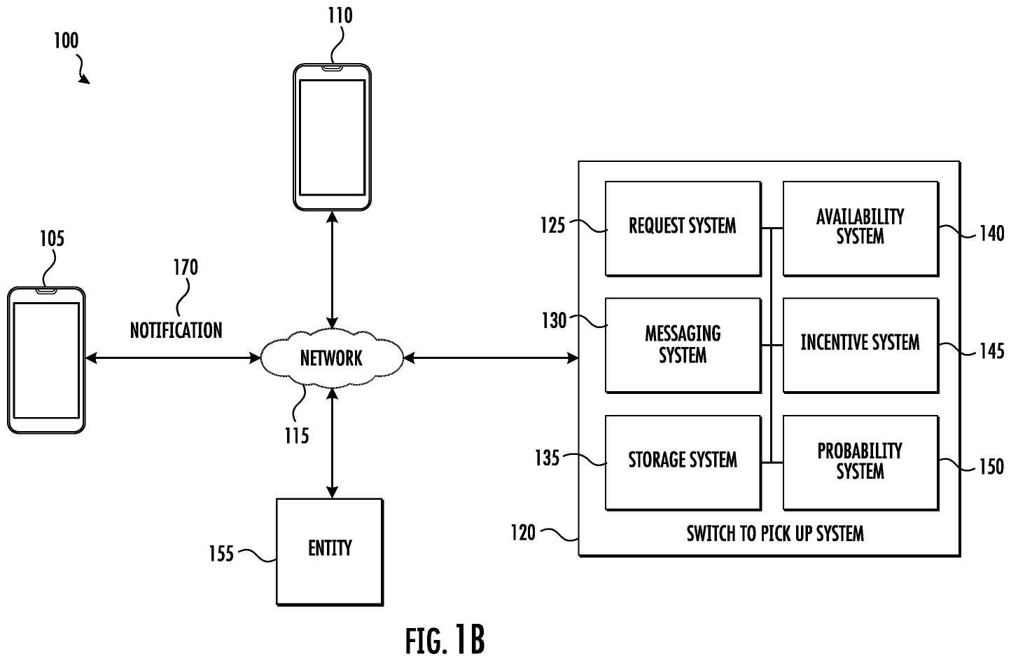

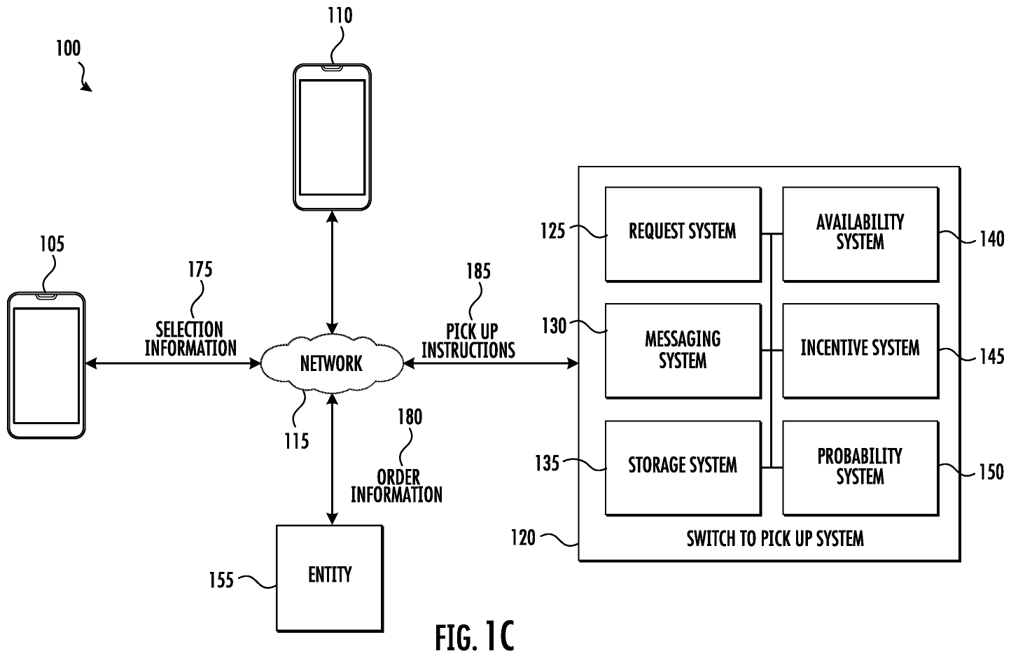

These and other examples will be explained in more detail with respect to FIG. 1A-FIG. 3.

FIG. 1A illustrates an example system 100 for determining an availability of a courier to deliver a food item to an individual according to an example. The system 100 may be part of or otherwise associated with a food delivery service. The food delivery service may be a network-based service that processes requests transmitted by remote computing devices (e.g., 105), identifies suitable service providers (e.g., restaurants, couriers), and enables service providers to fulfill the requests. The network-based food delivery service may be a service that allows an individual to access an application executing on a computing device (e.g., computing device 105) and place an order for food item(s) with a number of different restaurants or food preparation entities. Once the individual has placed an order for the food item(s), the network-based food delivery service identifies couriers that are available to pick up the food item(s) from the restaurant and deliver the food item(s) to a determined location of the individual.

However, in some cases, a courier may not be available to pick up the food item(s) from the restaurant and deliver the food item(s) to the individual. When this occurs, the system 100 may intelligently determine whether to prompt the individual to pick up the food item(s) rather waiting for a courier to become available and/or rather than risking her order being canceled.

For example, and as shown in FIG. 1A, the system 100 may include a switch to pick up system 120. The switch to pick up system 120 may use various signals and/or other information to intelligently determine whether and when to generate and/or to provide a pick up notification to the computing device 105 associated with the individual. In an example, the switch to pick up system 120 includes a request system 125, a messaging system 130, a storage system 135, an availability system 140, an incentive system 145 and a probability system 150. Although each of these systems are shown as separate systems, one or more of the systems may be combined. Additionally, although each system is shown as being part of the switch to pick up system 120, one or more of the systems may be remote from the switch to pick up system 120.

In order to intelligently determine whether to generate and provide a pick up notification to the computing device 105 associated with the individual, the switch to pick up system 120 may receive availability information 165 from a computing device 110 associated with a courier. The availability information 165 may be received from the computing device 110 associated with a courier over a network 115 or other communication channel.

In one example, the switch to pick up system 120 may receive availability information 165 from a courier when the courier logs into an application provided by or otherwise associated with a network-based food delivery service. In another example, the availability information 165 may be provided to the switch to pick up system 120 in response to input provided on the computing device 110. Although one computing device 110 is shown, the switch to pick up system 120 may receive availability information 165 from a number of different computing devices—each of which may be associated with different couriers.

In an example, the availability information 165 may be associated with a geographic area. Thus, when the availability information 165 is received, the availability system 140 may determine, using the availability information 165, a number of available couriers in a particular geographic area.

In some examples, the availability system 140 may use historical availability information to estimate or otherwise predict the number of available couriers for the particular geographic area. The prediction may be based on a particular time of day, day of the week, week of the month, etc.

For example, whenever availability information 165 is received by the switch to pick up system 120, the availability information 165, along with other associated information (e.g., a time period during which the courier is available, a day during which the courier is available, a geographic area that the courier is operating in or will otherwise service), is securely stored in the storage system 135. In another example, the courier may opt out of providing historical availability information to the switch to pick up system 120.

When historical availability information is available, the switch to pick up system 120 may estimate a number of available couriers for a geographic area and/or for a particular time of day, day of the week, etc. For example, the availability system 140, either alone or in combination with the probability system 150 and/or the storage system 135, may estimate or otherwise predict, based on the securely stored historical availability data, that X number of couriers are and/or will be available between 7:00 PM and 11:00 PM on Friday night in a particular geographic area. Likewise, the availability system 140 may estimate or otherwise predict, based on historical availability data, that Y number of couriers are and/or will be available in the particular geographic area between 3:00 PM and 7:00 PM on Friday.

In order to more accurately estimate and/or predict the number of available couriers in a geographic area and/or at a given time, the availability system 140 may compare the estimated or predicted number of available couriers to the number of times availability information 165 has been received by computing devices associated with different couriers. As this information is receive and/or determined, the availability system 140 and/or the probability system 150 may update and/or change the estimated number of available couriers in a given time frame and/or in a geographic area.

The switch to pick up system 120 may also receive a request for one or more items 160 from a computing device 105 associated with an individual, where a fulfillment mode of the request is delivery. In examples, the request for one or more items 160 to be fulfilled by delivery may be a food delivery request. The food delivery request 160 may be received by the switch to pick up system 120 via the network 115. In an example, the food delivery request 160 may include a request for a particular food item (e.g., a hamburger) or food items from a particular restaurant (e.g., Daryl's Burger Joint) or other entity 155.

The food delivery request 160 may also include, or otherwise be used to identify, profile information of the individual associated with the computing device 105. The profile information may include current location information of the computing device 105, a food item fulfilment history for the individual, a food item cancellation history for the individual, and so on. Any and all information associated with the individual that is collected by the switch to pick up system 120 is securely stored in the storage system 135. The individual may also prevent or otherwise opt out of the collection and storage of any or all of this information.

Although FIG. 1A shows the switch to pick up system 120 receiving a food delivery request 160 from a single computing device 105 via the network 115, the switch to pick up system 120 may receive any number of food delivery requests from a number of different computing devices.

As the food delivery request 160 is received by the switch to pick up system 120, the information associated with the food delivery request 160 is provided to the request system 125. The request system 125, either alone or in conjunction with the availability system 140, may determine a delivery condition for a geographic area associated with the computing device 105. In an example, the delivery condition may include information regarding the actual number (or estimated number) of available couriers in the geographic region and/or for a specified amount of time (e.g., the next 30 minutes from the time the food delivery request 160 was received, the next hour from the time the food delivery request 160 was received). The actual number (or estimated number) of available couriers in the geographic region may be compared against the actual number (or estimated number) of food delivery requests that have been received by the switch to pick up system 120.

If the difference between the actual number (or estimated number) of food delivery requests 160 and the actual number (or estimated number) of available couriers reaches a delivery condition threshold (e.g., a fraction of the food delivery requests do not currently have and/or are projected not to have a courier to deliver the food item to the individual), the probability system 150 may determine that a particular food delivery request 160 will go unfulfilled. In some examples, the determination is a determined likelihood or a determined probability that the food delivery request will go unfulfilled.

In some implementations, the determination that a food delivery request will go unfulfilled can occur after preparation of the food begins. For example, the availability system 140 can continuously monitor courier(s) to determine the availability of a courier to pick up an item as a particular food item is being prepared. The probability system 150 can determine, at a particular time point/threshold (e.g., 5 minutes left until the food preparation is complete), that no couriers are able to (or there is a low likelihood that a courier would be able to) arrive within a certain timeframe appropriate for picking up the item.

In some implementations, the request system 125 can determine a delivery condition after a courier is assigned to a particular food delivery request. For example, the delivery condition can be a condition that hinders the ability of a courier to pick up an item. This can include, for example, a traffic condition such as a congestion, a blockage, a travel way closure, accident, or other types of traffic conditions. The request system 125 and/or the availability system 140 can detect such a condition based on data from a courier user device (e.g., location data, message indicating the condition) and/or data from another computing system (e.g., traffic reporting system). The probability system 150 can determine that the courier may not arrive at the entity associated with the requested item (e.g., a restaurant) within a threshold time. For example, there may X number of minutes left until a certain perishable food item is ready for pick up/done being prepared. Based on the traffic condition, the probability system 150 can determine that there is a low likelihood that the courier will arrive within Y minutes, which is the time that it would take for the individual to pick up the requested item. In some implementations, Y can also include the time for the individual to return to the original delivery location with the picked up item (e.g., the round-trip time from the individual's home to the pick up location). Accordingly, it can be determined that the food delivery request may go unfulfilled.

If it is determined that the food delivery request 160 will go unfulfilled (or a probability that the food delivery request 160 will go unfulfilled exceeds a probability threshold) the messaging system 130 may generate a selectable notification that prompts the individual to switch a delivery option associated with the food delivery request 160 to a pick up option.

FIG. 1B illustrates the example system 100 of FIG. 1A in which a switch to pick up notification 170 is provided from the switch to pick up system 120 to the computing device 105 associated with the individual. The notification 170 may be provided on a user interface of the computing device 105.

As explained above, the notification 170 may be provided to the computing device 105 when it is determined that the food delivery request 160 will (or may) go unfulfilled. As described herein, such determination can be made prior to matching a courier to the food delivery request 160 (e.g., due to lack of sufficient courier availability) and/or after matching a courier to the food delivery request 160 (e.g., due to a change in a delivery condition delaying/preventing pick-up by the courier). The determination as to whether to provide the notification 170 to the computing device 105 associated with the individual may be based on various factors.

One of the factors may include a determination as to the eligibility of the entity 155 for individual-based pick-up. For example, the storage system 136 (or another memory) can store information associated with one or more entities 155. This information can indicate, for example, whether a particular entity permits or is capable of having an individual pick up a requested item. For example, a data field or flag can indicate that an entity 155 is eligible for pick up by an individual. In some implementations, eligibility for individual-based pick can be determined based on other information. For example, it can be determined that an entity 155 is eligible for individuals to pick up items based on data indicating the entity services “to-go” orders (e.g., found on a website associated with the entity). Additionally, or alternatively, eligibility for individual-based pick up can be determined based on one or more accessibility factors. The accessibility factors can include, for example, an entity's take-out offerings, location (e.g., the building is accessible to outside users), surrounding conditions (e.g., available walkways, walkway closures, weather), etc.

One of the factors may include a determined distance between a location of the entity (e.g. restaurant) 155 and a determined location of the individual. For example, it may be more convenient for the individual to travel two miles from her current location to the restaurant 155 in a rural area as compared to a city. Another factor may be the size or the quantity of food items in the food delivery request 160. For example, it may be more convenient for the individual to pick up one or two food items versus five or more food items.

Another factor may be a determined likelihood that the individual will cancel her order upon receiving the notification 170. In some examples, this cancelation likelihood may be based on historical food delivery requests associated with the individual. For example, an individual's willingness to pick-up an item can be determined based on whether (and/or how often) a user has picked up (or switched to pick up) previously requested item(s) (e.g., food items, other types of items). Information regarding whether (and/or how often) an individual has previously picked up requested items can be stored in the food item fulfillment history associated with that individual. For example, if the food item fulfillment history indicates that an individual has picked up (or switched to pick up) before or in an amount greater than a certain percentage of previous orders (e.g., 5, 10, 15%), it can be determined that the individual may be less likely to cancel an order upon receiving the notification 170. In another example, if the food item fulfillment history indicates that an individual has picked up (or switched to pick up) less than a certain percentage of previous orders, or has never picked up an item, it can be determined that the individual may be more likely to cancel an order upon receiving the notification 170. Additionally, or alternatively, an individual's willingness to pick-up an item can be determined based on historical data indicative an individual's price sensitivity (e.g., number of previous discounts obtained/used, proclivity for discounted times or items).

Another factor may be a preparation time of the food item(s) associated with the food delivery request 160. For example, if it will take the restaurant 155 one hour to prepare the food item(s) in the food delivery request 160 but the availability system 140 projects that couriers will be available at that time, the notification 170 may not be provided to the computing device 105. In another example, the notification 170 may be provided to the computing device 105 only while there is a shortage of available couriers.

Another factor may be a determined likelihood that the food delivery request 160 will go unfulfilled due to lack of couriers and/or the restaurant 155 closing before the food items in the food delivery request 160 can be prepared and/or picked up. For example, if the availability system 140 and/or the probability system 150 determines or projects that the food delivery request 160 will go unfulfilled, or will most likely go unfulfilled, the notification 170 may be provided to the computing device 105.

Another factor may be a projected or anticipated number of food delivery requests received at a time relevant to the request (e.g., the current time, a scheduled delivery time). The projected or anticipated number of food delivery requests may be based on historical data, context data (e.g., sporting event, holiday), or inclement weather which may affect the demand for food delivery. For example, if historical data indicates that the number of food delivery requests on Fridays scheduled for delivery between 6:00 PM and 8:00 PM is particularly large, a notification 170 may be provided to a computing device 105 associated with an individual who submits a food delivery request 160 to be delivered on a Friday at 7:00 PM. The projected or anticipated number of food delivery requests may also be based on a number of users currently interacting with the network-based food delivery service who have not yet completed the checkout process.

In another example, the total cost associated with the food delivery request 160 may be a factor in determining whether to provide the notification 170 to the computing device 105. For example, if a first individual submits a food delivery request 160 having an associated cost of one-hundred dollars and a second individual submits a food delivery request 160 having an associated cost of ten dollars, the notification 170 may be provided to the computing device associated with the second individual. In another example, a determined profit for the courier and/or the food delivery service provider may be a factor in determining whether to provide the notification 170 to the computing device 105. In yet another example, a current time of day may be a factor in determining whether to provide the notification 170 to the computing device 105. Although specific examples have been given, other factors may be considered when determining whether to provide the notification 170 to the computing device.

In some examples, the messaging system 130 may provide the notification 170 to the computing device 105 when a food delivery request 160 is received. For example, the messaging system 130 may provide the notification 170 to the computing device 105 when a checkout process has been completed. In other examples, the messaging system 130 may provide the notification 170 to the computing device 105 during the checkout process before the food delivery request has been submitted.

In another example, the messaging system 130 may provide the notification 170 to the computing device 105 if a courier has not been found within a threshold amount of time (e.g., five minutes, ten minutes, thirty minutes) of the food delivery request 160 being received and/or within a threshold amount of time of a checkout process being completed. In yet another example, the messaging system 130 may provide the notification 170 to the computing device 105 when an available courier declines to accept a delivery assignment associated with the food delivery request 160.

The switch to pick up system 120 may also include an incentive system 145. The incentive system 145 may determine one or more incentives to include with the notification 170. The incentives may be used to encourage the individual to select the notification 170 that changes the delivery option to the pick up option. In some examples, the type and/or value of the incentive may be based on profile information of the individual associated with the computing device 105.

In an example, the incentive may be associated with a monetary value. The value of the incentive and/or the type of the incentive may be determined by the incentive system 145. For example, the incentive may be a discount off of the current cost of the food item(s) in the food delivery request 160. In another example, the incentive may be a discount off of food item(s) of a future food delivery request 160. In another example, the incentive may be a reduced delivery fee associated with a future food delivery request 160.

In some examples, the incentive may be associated with an additional item that can be added to food delivery request 160 for the individual. For instance, the incentive can include an offer to add an additional item to the individual's order, at a reduced cost (e.g., discounted or no cost) for the item. In some implementations, the additional item can be determined based on an individual's previously requested items (e.g., as stored in the food item fulfillment history). The additional item offered for inclusion can be based on one or more previous items associated with the individual (e.g., a food item that the user has previously requested from the entity or a similar entity). In some implementations, the additional item offered for inclusion can be based on one or more previous items associated with other individual(s) (e.g., food items that other users have previously requested from the entity or a similar entity). In some implementations, items for a particular entity (e.g., to be offered as an additional item) can be filtered by preparation time to ensure they can be included in an individual's request/order without disrupting the timing of the originally requested items (e.g., the pick up time).

In some examples, the incentive may be time-based. For example, when the notification 170 is provided to the computing device 105, the incentive may be a first incentive or have a first value. However, as time passes, the incentive may change to a second incentive or have a second value. The second incentive or the second value may be less than the first incentive or the first value. In another example, the opposite may be true. In yet another example, the incentive may be a “negative incentive.” For example, the incentive system 145 may determine that if the individual waits for a courier to become available, the individual will have to pay X more dollars for delivery due to the lack of available couriers.

FIG. 1C illustrates the example system 100 of FIG. 1B in which pick up instructions 185 are provided to the computing device 105 associated with the individual in response to the individual selecting the switch to pick up notification 170 (FIG. 1B) according to an example. For example, once the notification 170 has been provided to the user interface of the computing device 105, the individual may select or otherwise provide input that selects the notification 170.

The selection information 175 is provided to the messaging system 130. The messaging system 130 may then determine and/or provide pick up instructions 185 to the computing device 105 via the network 115. In some examples, the pick up instructions 185 include driving and/or walking directions to the restaurant, a map that displays the location of the restaurant, an estimated time at which the food item(s) in the food delivery request 160 will be available for pick up, and so on. In some implementations, the pick up instructions can include an offer for transportation (e.g., via a car, a bike, public transit) to the restaurant. The offer for transportation can include an offer for a rideshare service. The offer for transportation can be provided at a discounted cost, or no cost, to the individual.

In some examples, receipt of the selection information 175 may also cause the messaging system 130 to provide order information 180 to the restaurant 155. The order information 180 includes information about the food item(s) associated with the food delivery request 160. In other examples, the order information 180 is provided to the restaurant 155 when the food delivery request 160 is received. In yet another example, the order information 180 is provided to the restaurant 155 when a courier is available and has accepted the delivery assignment. Receipt of the selection information 175 may also cause the availability system 140 to stop looking for available couriers to deliver the food item(s) in the food delivery request 160 to the location of the individual.

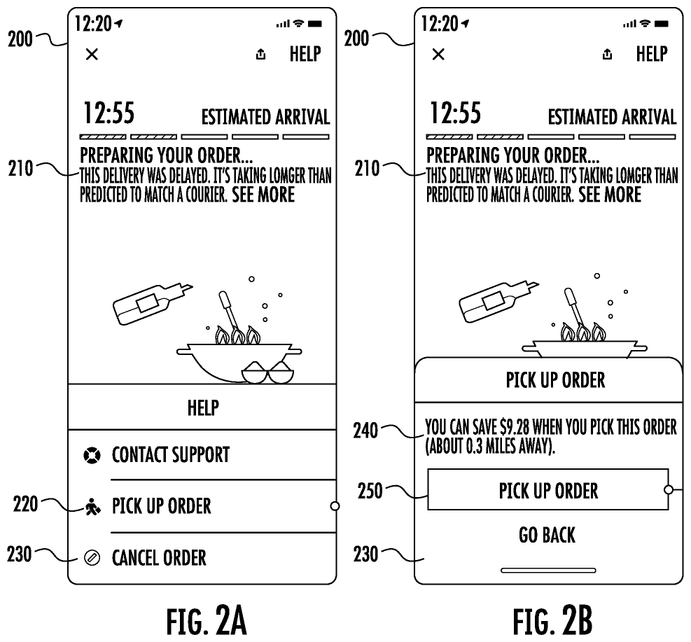

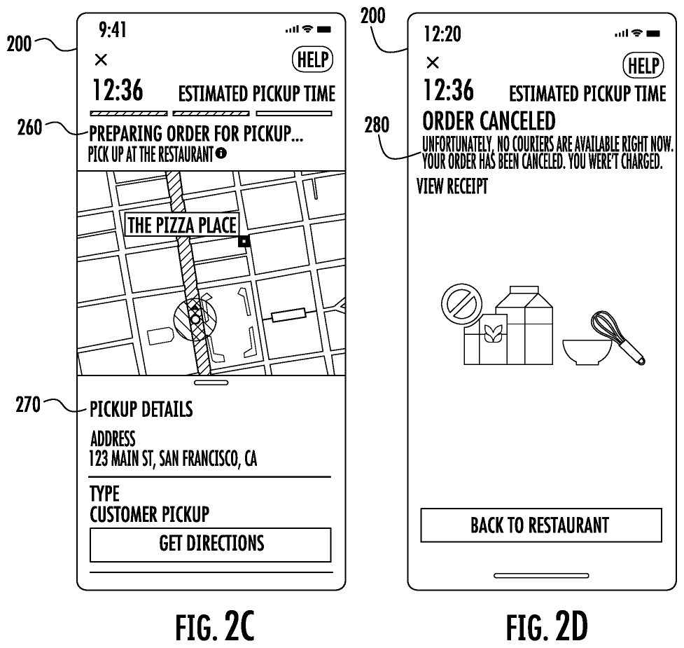

FIG. 2A illustrates an example user interface 200 that includes a switch to pick up notification according to an example. The user interface 200 may be provided to or otherwise displayed on a computing device that accesses the system 100 shown and described with respect to FIG. 1A-FIG. 1C. For example, the user interface 200 may be provided to or otherwise displayed on the computing device 105.

As shown in FIG. 2A, the user interface 200 may include a status indicator 210. The status indicator 210 may provide information about a status of the food item(s) in the food delivery request (e.g., a food delivery request 160 (FIG. 1A)). The status indicator 210 in this example indicates that the delivery of the food items is delayed due to lack of couriers. In addition to the status indicator 210, the user interface 200 may include a selectable “pick up order” 220 element and a “cancel order” 230 element.

FIG. 2B illustrates another example user interface 200 that is provided to a computing device according to an example. In this example, the user interface 200 includes an incentive 240 along with a selectable element that enables the individual to change her request from delivery to pick up. As shown in FIG. 2B, the incentive 240 indicates that the individual can save $9.28 if she picks up the order. The user interface 200 also indicates that the restaurant is “about 0.3 miles away.” In this example, the user interface 200 also includes a selectable “pick up order” element 250 that, when selected, indicates the individual is going to pick up her food item(s). In response to the selection of the pick up order element 250, the system will stop looking for couriers to deliver the food items to the location of the individual.

In some implementations, the incentive 240 can indicate that the individual will obtain the food items faster if the individual switches to pick up. This can include, for example, an estimated time savings to the individual if the food items are picked up by the individual.

FIG. 2C illustrates the example user interface 200 in response to the individual selecting the switch to pick up selectable element according to an example. As shown in FIG. 2C, the user interface 200 includes an updated status indicator 260 that indicates that the restaurant (e.g., the restaurant 155 (FIG. 1A)) is “preparing the order for pickup.”

The user interface 200 also includes pick up details 270. The pick up details 270 may include an address of the restaurant and/or a map showing the current location of the individual and/or the location of the restaurant. The user interface 200 may also include directions from the current location of the individual to the location of the restaurant and/or a selectable option that causes the directions to be displayed on the user interface 200.

FIG. 2D illustrates the example user interface 200 that is provided to the computing device when an order is canceled according to an example. The user interface 200 shown in FIG. 2D may be provided to the computing device when the switch to pick up system determines that no couriers are available and/or when the individual has not selected the switch to pick up notification. When an order is canceled, a cancelation status indication 280 may provide information or otherwise indicate why the order was canceled. In this example, the cancelation status indication states that the order was canceled because there are “no couriers available right now.”

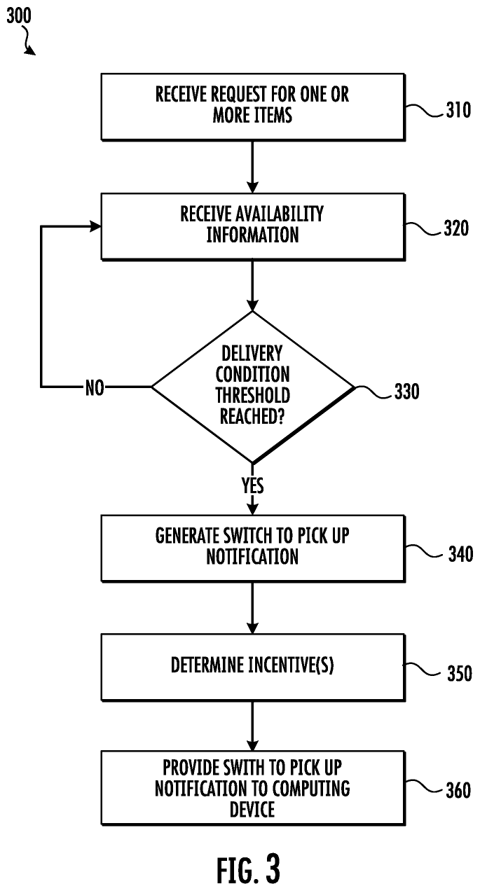

FIG. 3 illustrates a method 300 for determining whether to provide a switch to pick up notification to a computing device associated with an individual according to an example. In an example, the method 300 may be performed by one or more systems of the system 100 shown and described with respect to FIG. 1A-FIG. 1C.

Method 300 begins when a request for one or more items is received (310), a fulfillment mode of the request being delivery. The request for one or more items to be fulfilled by delivery may be a food delivery request. The food delivery request may include a request for one or more food items prepared by a restaurant. The food delivery request may also include location information associated with the individual that provided the food delivery request and/or profile information associated with the individual.

In some examples, the system may also receive (320) courier availability information. The courier availability information may include, for example, courier status, location information of the courier, distance between the courier and a pickup location and/or a delivery location, courier delivery request acceptance/denial information, estimated travel time information, etc. The courier availability information may be used to attempt to identify a courier to deliver the food delivery request. For instance, the system may select a courier based on one or more conditions associated with the courier availability information. The selected courier may then perform the food delivery request.

Based on receiving this information, the system may determine (330) whether a delivery condition threshold has been reached. In one example, the delivery condition threshold is a determination that a number of received food delivery requests exceeds or is projected to exceed a number of available couriers. In some examples, this determination may be based on a current status of the food item(s) in the various food delivery requests and/or on a current delivery status of the available couriers. For example, the system may have received ten different food item requests. Of those ten, five may be out for delivery, four may be in preparation and one may have just been received. Additionally, of the five that are out for delivery, two couriers may be within two minutes of their destination, one courier may have just picked up the food item(s) from the restaurant, and two couriers may be on their way to the restaurant. Using this information, the system may be able to better determine when couriers will or may be available. Accordingly, the delivery condition threshold may be updated and/or adjusted using this information.

In at least one example, one or more incentives to provide to the individual may be determined as part of the delivery condition. For instance, a current and/or future monetary-based, time-based, item-based, or event-based incentive may be provided to the individual. In such an example, the individual may be able to select one or more offered incentives. Alternatively, one or more incentives may be automatically provided to the individual. Although a delivery condition threshold is specifically mentioned, various other factors, either alone or in combination with the delivery condition threshold, may be used to determine whether to generate and provide a switch to pick up notification to the individual.

If it is determined that the delivery condition threshold is not reached, the system may continue to collect or receive (320) courier availability information and/or to attempt to identify a courier to deliver the food delivery request. The system may then periodically check to determine (330) whether a delivery condition threshold has been reached, until a courier has been selected and the courier has accepted the food delivery request. However, if it is determined that the delivery condition threshold has been reached, the system generates (340) a selectable switch to pick up notification. When selected, the switch to pick up notification causes the fulfillment mode of the food delivery request to be changed to a food pick up request such as described above.

In addition to generating the switch to pick up notification, the system may also determine (350) one or more incentives to provide to the individual. The incentives are used to encourage the individual to change the fulfillment mode of her food delivery request to a food pick up request.

Once the switch to pick up notification has been generated and the incentives have been identified, the switch to pick up notification is provided (360) to the computing device of the individual.

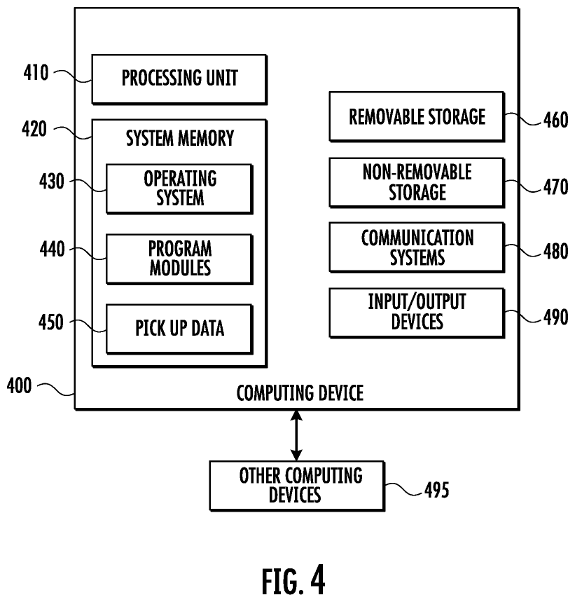

FIG. 4 is a system diagram of a computing device 400 according to an example. The computing device 400, or various components and systems of the computing device 400, may be integrated or associated with a switch to pick up system, a request system, a messaging system, a storage system, an availability system, an incentive system and/or a probability system. As shown in FIG. 4, the physical components (e.g., hardware) of the computing device are illustrated and these physical components may be used to practice the various aspects of the present disclosure.

The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400 and one or more program modules 440. The program modules 440 may be responsible for gathering or determining food delivery requests, availability information, selection of pick up notifications, tracking of incentives and so on (collectively referred to herein as pick up data 450). A number of different program modules and data files may be stored in the system memory 420. While executing on the processing unit 410, the program modules 440 may perform the various processes described above.

The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, routing engines, gateways, signings systems and the like. Examples of communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
receiving, from a computing device, a request for one or more items, a fulfillment mode of the request being delivery;
based on receiving the request, determining a delivery condition associated with a determined geographic area associated with the computing device;
based on determining that the delivery condition reaches a delivery condition threshold, generating a selectable notification for the computing device, the selectable notification notifying an individual associated with the computing device that the delivery condition reaches the delivery condition threshold;
providing the selectable notification to the computing device; and
based on receiving a selection of the selectable notification, changing the fulfillment mode of the request to pick up.

2. The method of claim 1, wherein at least one of the one or more delivery conditions is based, at least in part, on a determination as to whether a number of requests for the determined geographic area exceeds a number of available couriers for the determined geographic area.

3. The method of claim 1, further comprising determining, based at least in part, on historical data associated with the individual, a probability of the individual cancelling the request.

4. The method of claim 3, wherein providing the selectable notification to the computing device occurs when the probability of the individual cancelling the request is above a cancellation threshold.

5. The method of claim 1, further comprising determining an incentive for the individual to select the selectable notification.

6. The method of claim 5, wherein the incentive is based, at least in part, on an amount of time between when the request is received and when the selectable notification is provided to the computing device.

7. The method of claim 5, wherein the incentive is based, at least in part, on a determined cost for a courier to deliver the one or more items to a location of the individual.

8. The method of claim 5, wherein the incentive is based, at least in part, on a determined distance between a location of the individual and a location of an entity that is preparing the one or more items.

9. The method of claim 1, wherein the selectable notification includes an estimated time period during which a courier is available.

10. The method of claim 1, further comprising, based on receiving the selection of the selectable notification, providing an item preparation request to an entity that is preparing the one or more items associated with the request.

11. A method, comprising:
receiving, from a computing device located at a first location, a request for one or more items, a fulfillment mode of the request being delivery, the request including an item to be prepared by an entity, the entity being located at a second location;
based on receiving the request, determining an availability of a courier to deliver the item from the second location to the first location;
based on determining that the courier is not available, generating a pick up notification; and
causing the pick up notification to be displayed on a user interface of the computing device.

12. The method of claim 11, further comprising:
after determining the courier is not available, monitoring availability of one or more courier; and
based on receiving a selection of the pick up notification, stopping the monitoring.

13. The method of claim 11, wherein the determination that the courier is not available comprises determining that the courier is not available after a threshold amount of time has passed since the request has been received.

14. The method of claim 11, further comprising generating the pick up notification based, at least in part on a determined distance between the first location and the second location.

15. The method of claim 11, further comprising generating the pick up notification based, at least in part, on a number of items associated with the request.

16. The method of claim 11, further comprising:
determining an incentive associated with the pick up notification; and
providing the incentive with the pick up notification.

17. The method of claim 11, further comprising causing the pick up notification to be removed from the user interface of the computing device when the courier is available.

18. The method of claim 11, further comprising:
determining directions between the first location and the second location; and
causing the directions to be displayed on the user interface of the computing device based on receiving a selection of the pick up notification.

19. A system, comprising:
a processor; and
a memory communicatively coupled to the processor and storing instructions that, when executed by the processor, perform operations, comprising:
receiving, from a computing device, a request for one or more items, a fulfillment mode of the request being delivery;
based on receiving the request, determining whether a difference between a number of requests for a determined geographic area associated with the request and a number of available couriers for the determined geographic area reaches a difference threshold;
based on determining that the difference reaches the difference threshold, generating a selectable notification for the computing device, the selectable notification notifying an individual associated with the computing device that the difference reached the difference threshold;
providing the selectable notification to the computing device; and
based on receiving a selection of the selectable notification, changing the fulfillment mode of the request to pick up.

20. The system of claim 19, further comprising instructions for:
determining an incentive for the individual; and
providing the incentive with the selectable notification.
